(19) United States
(12) Patent Application Publication
(10) Pub. No.: US 2025/0015542 A1
(43) Pub. Date: Jan. 9, 2025

(54) ELECTRICAL CONNECTOR AND ELECTRICAL CONNECTOR ASSEMBLY WITH IMPROVED SHIELDING EFFECT

(71) Applicant: DONGGUAN LUXSHARE TECHNOLOGIES CO., LTD, Dongguan City (CN)

(72) Inventors: Chenhui ZENG, Dongguan City (CN); Jiaqi CAO, Dongguan City (CN); Hengshan CHENG, Dongguan City (CN)

(73) Assignee: DONGGUAN LUXSHARE TECHNOLOGIES CO., LTD, Dongguan City (CN)

(21) Appl. No.: 18/897,200

(22) Filed: Sep. 26, 2024

Related U.S. Application Data
(63) Continuation-in-part of application No. 17/834,523, filed on Jun. 7, 2022.
(63) Continuation-in-part of application No. 17/839,873, filed on Jun. 14, 2022.
(63) Continuation-in-part of application No. 17/958,829, filed on Oct. 3, 2022.

(30) Foreign Application Priority Data
Jun. 16, 2021 (CN) 202110665729.0
Jun. 16, 2021 (CN) 202121340213.0
Oct. 12, 2021 (CN) 202122460467.2
Aug. 14, 2024 (CN) 202411119043.1

(51) Int. Cl. H01R 13/6592; H01R 13/627; H01R 13/635

(52) U.S. Cl. CPC H01R 13/6592; H01R 13/627; H01R 13/635

(57) ABSTRACT

An electrical connector includes an insulating body and a first terminal module. The insulating body includes a main body and an extension plate. The main body defines a first installation groove. The first terminal module includes a first conductive mounting block, a first terminal assembly, a first cable and a first ground plate. The first terminal assembly includes a first insulating block and a number of first conductive terminals. Each first conductive terminal includes a mating portion and a connecting portion. The first cable includes a first shielding layer sandwiched between the first conductive mounting block and the first ground plate. An electrical connector assembly having the electrical connector is also disclosed.

### CROSS-REFERENCE TO RELATED APPLICATIONS

This patent application claims priority of a Chinese Patent Application No. 202411119043.1, filed on Aug. 14, 2024 and titled “ELECTRICAL CONNECTOR AND ELECTRICAL CONNECTOR ASSEMBLY WITH IMPROVED SHIELDING EFFECT”, and is a continuation-in-part of U.S. patent application Ser. No. 17/834,523, filed on Jun. 7, 2022 and titled “STRAP CONNECTOR AND ASSEMBLY THEREOF WITH ENHANCED MATING RETENTION FORCE”, which claims priority of a Chinese Patent Application No. 202110665729.0, filed on Jun. 16, 2021, a continuation-in-part of U.S. patent application Ser. No. 17/839,873, filed on Jun. 14, 2022 and titled “CONNECTOR AND ASSEMBLY THEREOF WITH FOOLPROOF STRUCTURE”, which claims priority of a Chinese Patent Application No. 202121340213.0, filed on Jun. 16, 2021, and a continuation-in-part of U.S. patent application Ser. No. 17/958,829, filed on Oct. 3, 2022 and titled “PULL STRAP CONNECTOR AND ASSEMBLY THEREOF WITH IMPROVED LOCKING FEATURES”, which claims a priority of a Chinese Patent Application No. 202122460467.2, filed on Oct. 12, 2021, the entire content of which is incorporated herein by reference.

### TECHNICAL FIELD

The present disclosure relates to an electrical connector and an electrical connector assembly, and belongs to the technical field of connectors.

### BACKGROUND

An existing connector assembly generally includes an electrical connector and a mating connector mating with the electrical connector. The electrical connector includes an insulating body, a plurality of conductive terminals, a locking piece and a pulling strap. The conductive terminals are received in the insulating body. The locking piece is located on one side of the insulating body. The pulling strap is connected to the locking piece. The locking piece includes a hook located on one side of the insulating body. The mating connector includes a slot for mating with the hook.

However, as the requirements for data transmission continue to increase, how to solve problems such as signal crosstalk is a technical problem faced by those of ordinary skill in the art.

### SUMMARY

An object of the present disclosure is to provide an electrical connector and an electrical connector assembly which are beneficial to improve signal transmission quality.

In order to achieve the above object, the present disclosure adopts the following technical solution: an electrical connector, including: an insulating body, the insulating body including a main body and an extension plate protruding beyond the main body along a mating direction, the main body defining a first installation groove; and a first terminal module, the first terminal module including a first conductive mounting block, a first terminal assembly provided on the first conductive mounting block, a first cable connected to the first terminal assembly, and a first ground plate abutting against the first conductive mounting block; the first terminal assembly including a first insulating block and a plurality of first conductive terminals provided on the first insulating block; each first conductive terminal including a mating portion and a connecting portion; the connecting portion of the first conductive terminal being electrically connected to the first cable; the first cable including a first shielding layer which is sandwiched between the first conductive mounting block and the first ground plate; wherein the first terminal module at least partially passes through the first installation groove; the first conductive mounting block, the first insulating block and the extension plate together form at least part of a tongue plate of the electrical connector; the tongue plate is configured to be inserted into a mating slot of a mating connector.

In order to achieve the above object, the present disclosure adopts the following technical solution: an electrical connector assembly, including: an electrical connector, the electrical connector including: an insulating body, the insulating body including a main body and an extension plate protruding beyond the main body along a mating direction, the main body defining a first installation groove; and a first terminal module, the first terminal module including a first conductive mounting block, a first terminal assembly, a first cable connected to the first terminal assembly, and a first ground plate abutting against the first conductive mounting block; the first terminal assembly including a first insulating block and a plurality of first conductive terminals; each first conductive terminal including a mating portion and a connecting portion; the connecting portion of the first conductive terminal being electrically connected to the first cable; the first cable including a first shielding layer which is sandwiched between the first conductive mounting block and the first ground plate; wherein the first terminal module at least partially passes through the first installation groove; the first conductive mounting block, the first insulating block and the extension plate together form at least part of a tongue plate of the electrical connector; the tongue plate is configured to be inserted into a mating slot of a mating connector; and a mating connector, the mating connector including: a mating insulating body, the mating insulating body including a plurality of wall portions and a mating slot surrounded by the plurality of wall portions; the plurality of wall portions including a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the tongue plate of the electrical connector; a plurality of mating terminals, the plurality of mating terminals being provided on the mating insulating body; each mating terminal including an elastic mating arm which extends into the mating slot and is configured to contact the first conductive terminal of the electrical connector; and a metal shell, the metal shell at least partially covering the mating insulating body; the metal shell including a first side wall, a second side wall disposed opposite to the first side wall, a first connecting wall connecting one side of the first side wall and one side of the second side wall, and a second connecting wall connecting another side of the first side wall and another side of the second side wall.

The electrical connector and the electrical connector assembly of the present disclosure include the first terminal module. The first terminal module includes the first conductive mounting block, the first terminal assembly, the first cable connected to the first terminal module, and the first ground plate abutting against the first conductive mounting block. The first conductive mounting block, the first insulating block, and the extension plate together form at least part of the tongue plate of the electrical connector. The tongue plate is configured to be inserted into the mating slot of the mating connector. The present disclosure improves the quality of signal transmission by providing the first conductive mounting block and the first ground plate.

### BRIEF DESCRIPTION OF DRAWINGS

FIG. 1 is a schematic perspective view of an electrical connector assembly in accordance with a first embodiment of the present disclosure, in which an electrical connector is mated with a mating connector;

FIG. 2 is a perspective view of FIG. 1 from another angle;

FIG. 3 is a partially exploded perspective view of FIG. 1, in which the electrical connector and the mating connector are separated from each other;

FIG. 4 is a partially exploded perspective view of FIG. 3 from another angle;

FIG. 5 is an exploded perspective view of the mating connector shown in FIG. 3;

FIG. 6 is an exploded perspective view of FIG. 5 from another angle;

FIG. 7 is a front view of the electrical connector shown in FIG. 3;

FIG. 8 is a rear view of the electrical connector of FIG. 3;

FIG. 9 is a partially exploded perspective view of the electrical connector shown in FIG. 3;

FIG. 10 is a partially exploded perspective view of FIG. 9 from another angle;

FIG. 11 is a further exploded perspective view of FIG. 9;

FIG. 12 is an exploded perspective view of FIG. 11 from another angle;

FIG. 13 is a right view of a first terminal module and a second terminal module in FIG. 11;

FIG. 14 is a perspective view of the first terminal module and the second terminal module in FIG. 11;

FIG. 15 is a perspective view of FIG. 14 from another angle;

FIG. 16 is a perspective view of FIG. 14 from another angle;

FIG. 17 is a partial enlarged view of frame portion D in FIG. 16;

FIG. 18 is a partially exploded perspective view of the first terminal module in FIG. 16;

FIG. 19 is a partial enlarged view of circled portion E in FIG. 18;

FIG. 20 is a partial enlarged view of circled portion F in FIG. 18;

FIG. 21 is an exploded perspective view of the first terminal module in FIG. 14;

FIG. 22 is an exploded perspective view of FIG. 21 from another angle;

FIG. 23 is an exploded perspective view of FIG. 21 from yet another angle;

FIG. 24 is a partial enlarged view of frame portion G in FIG. 21;

FIG. 25 is a partial enlarged view of frame portion H in FIG. 21;

FIG. 26 is a schematic cross-sectional view taken along line I-I in FIG. 3;

FIG. 27 is a schematic cross-sectional view taken along line J-J in FIG. 3;

FIG. 28 is a partial enlarged view of frame portion K in FIG. 26;

FIG. 29 is a partial enlarged view of frame portion L in FIG. 26;

FIG. 30 is a schematic perspective view of the first terminal module and the second terminal module of the electrical connector in accordance with a second embodiment of the present disclosure;

FIG. 31 is a perspective view of FIG. 30 from another angle;

FIG. 32 is a partially exploded perspective view of the first terminal module and the second terminal module in FIG. 31;

FIG. 33 is a partially exploded perspective view of FIG. 32 from another angle;

FIG. 34 is an exploded perspective view of the first terminal module in FIG. 32;

FIG. 35 is a partial enlarged view of circled portion O in FIG. 34;

FIG. 36 is a partial enlarged view of circled portion P in FIG. 34;

FIG. 37 is an exploded perspective view of the first terminal module and the second terminal module in FIG. 33;

FIG. 38 is a schematic cross-sectional view of FIG. 26 in accordance with the second embodiment of the present disclosure; and

FIG. 39 is a partial enlarged view of frame portion Q in FIG. 38.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

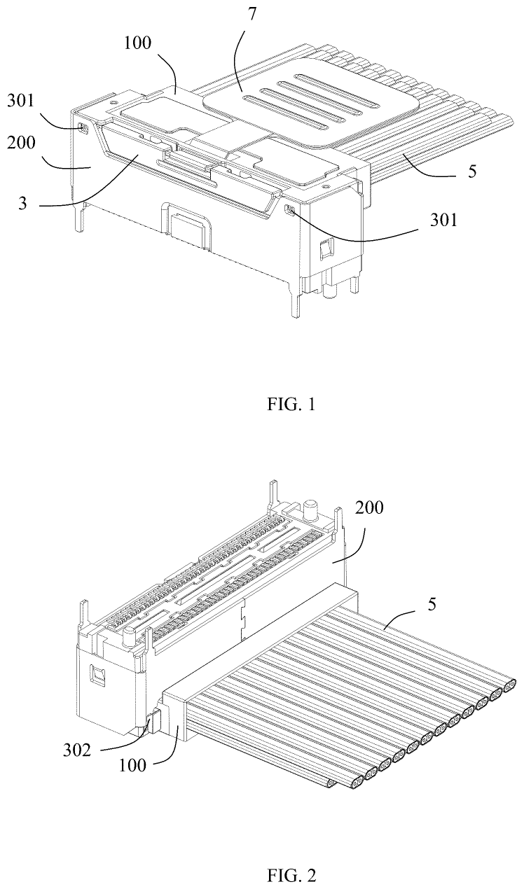

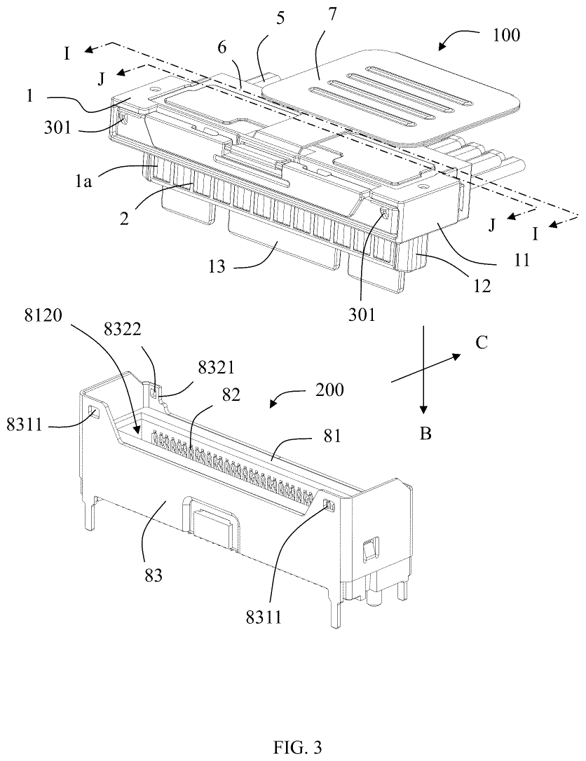

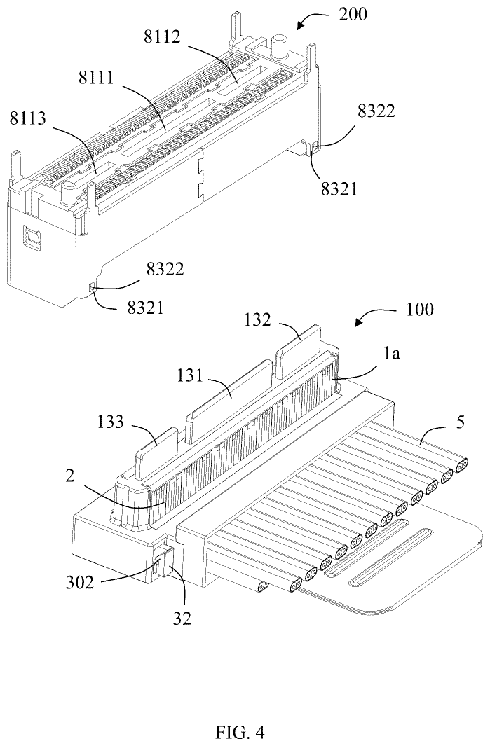

Referring to FIG. 1 to FIG. 4, the present disclosure discloses a connector assembly, which includes an electrical connector 100 and a mating connector 200 for matching with the electrical connector 100. In the illustrated embodiment of the present disclosure, the electrical connector 100 is a pull strap connector and a cable end connector. The mating connector 200 is a board-end connector and configured to be mounted on a circuit board (not shown). Referring to FIG. 3, the electrical connector 100 is configured to mate with the mating connector 200 along a mating direction B (for example, a top-to-bottom direction) to realize data and/or power transmission.

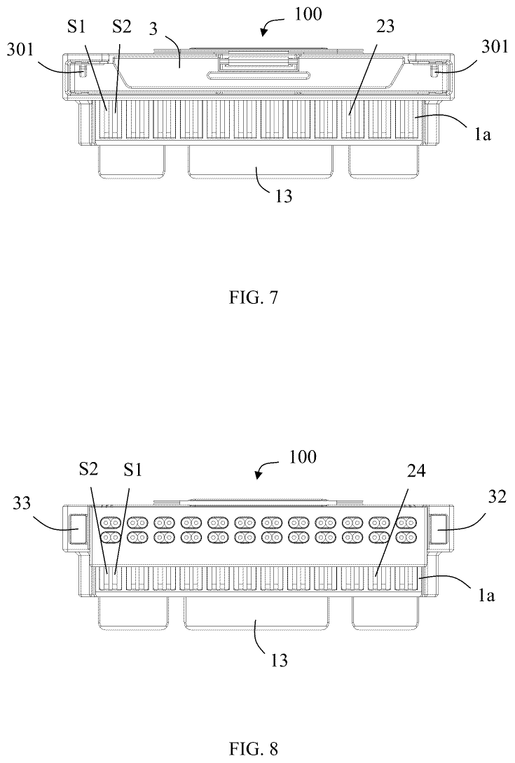

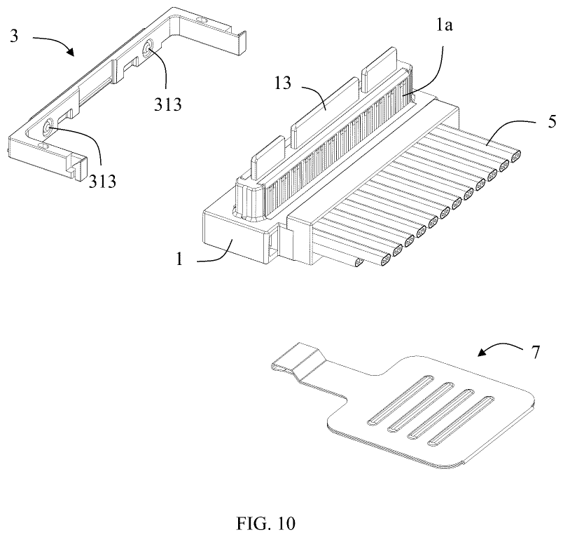

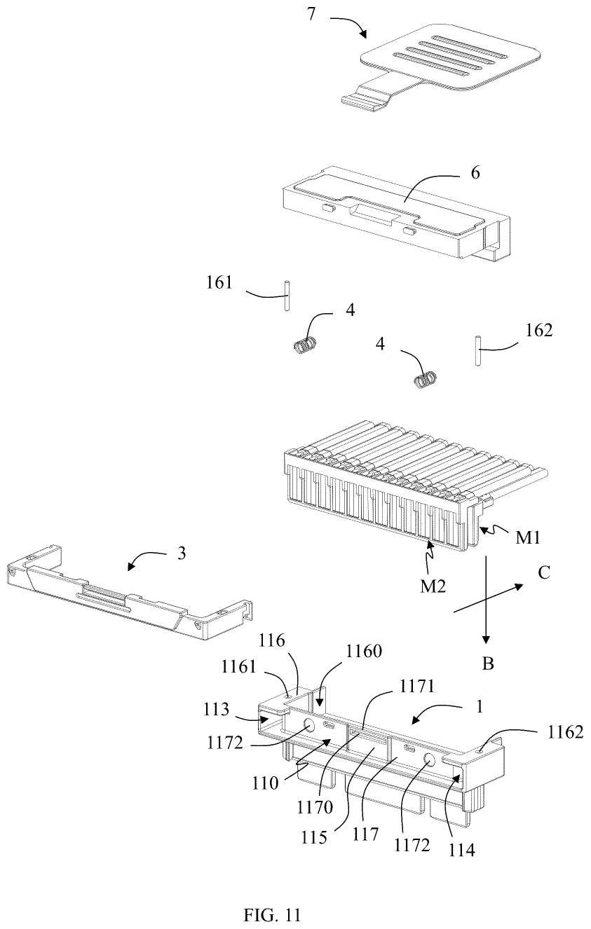

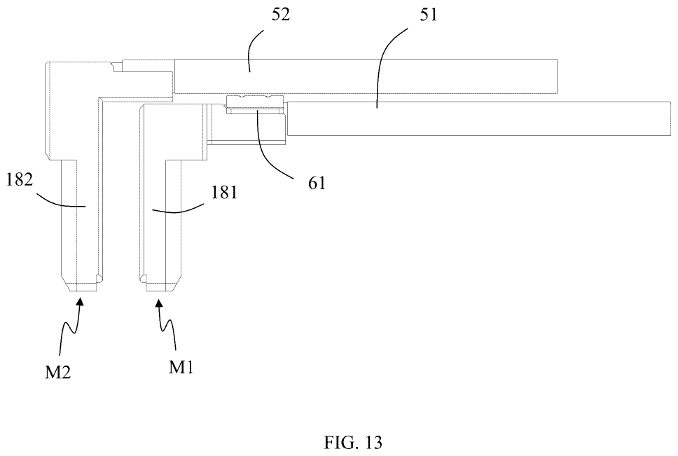

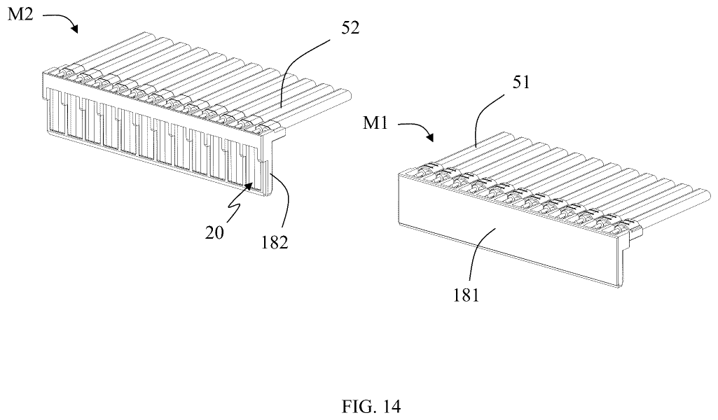

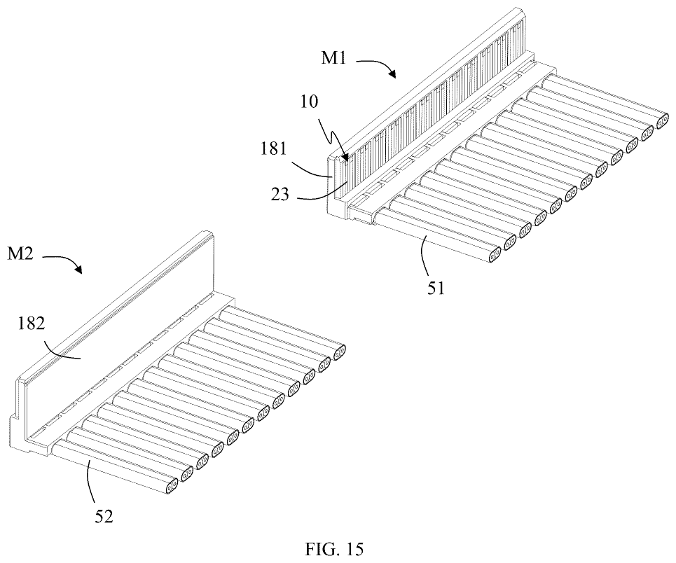

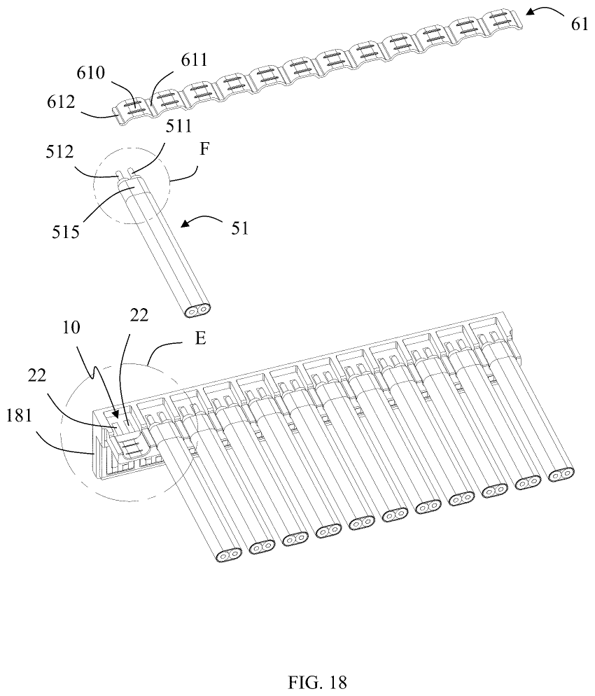

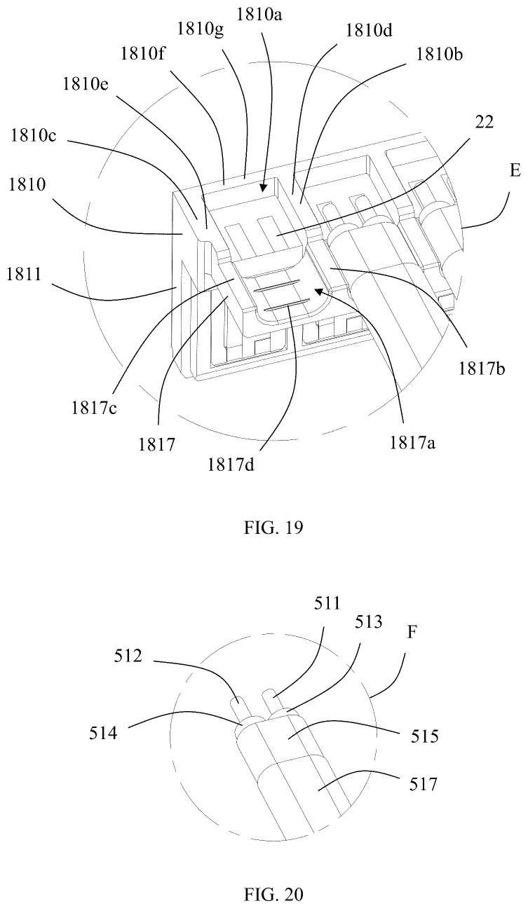

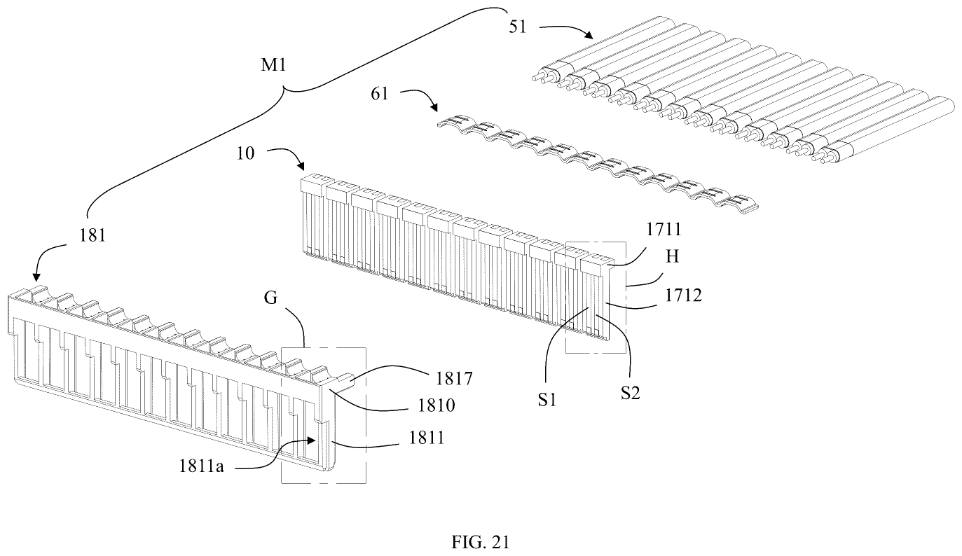

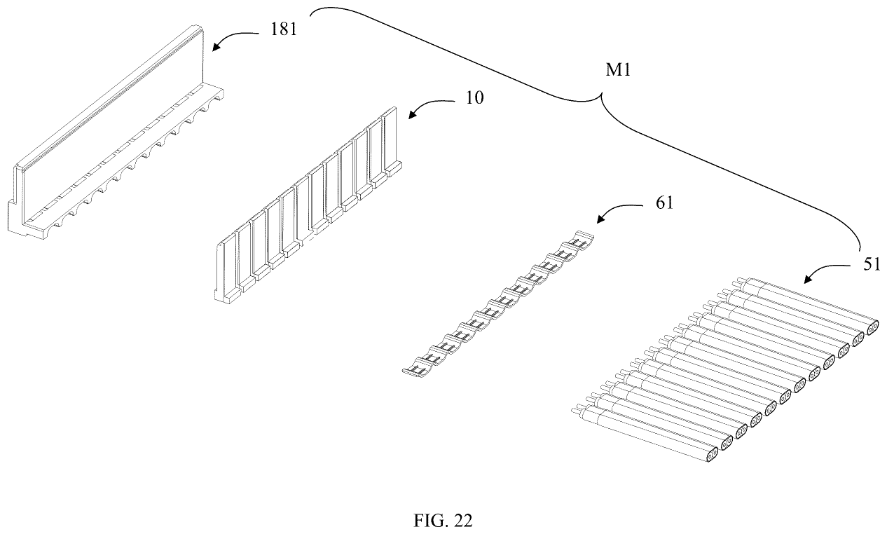

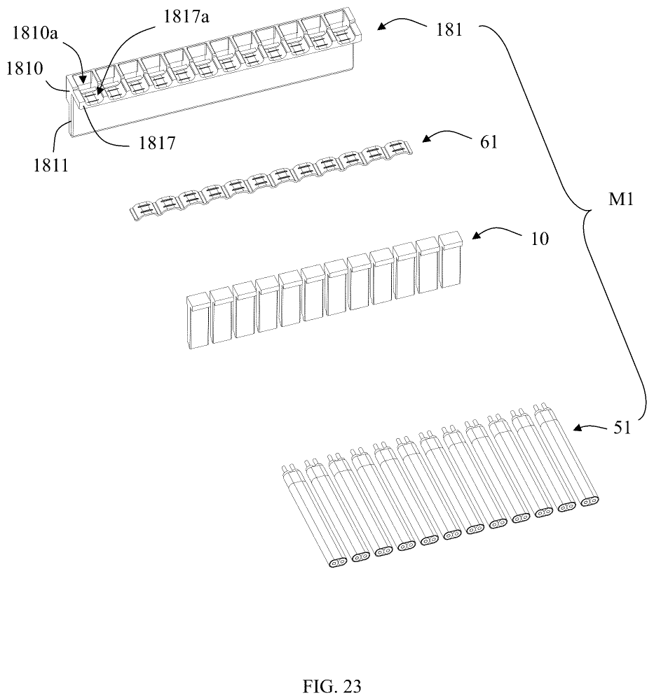

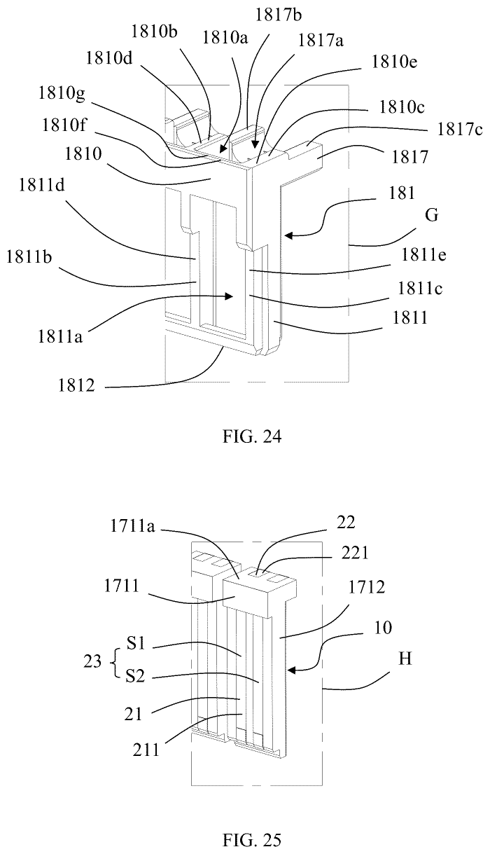

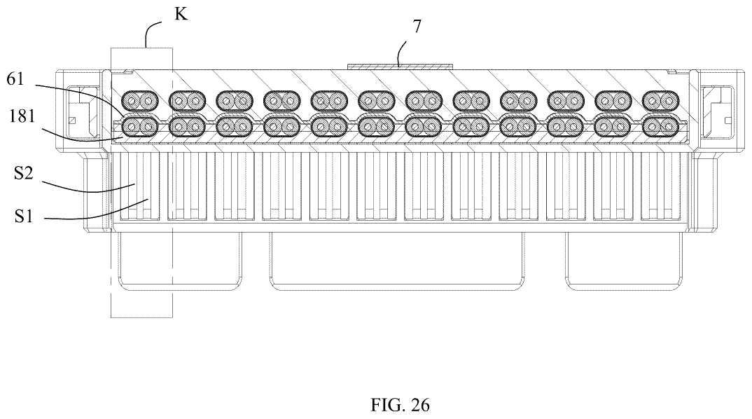

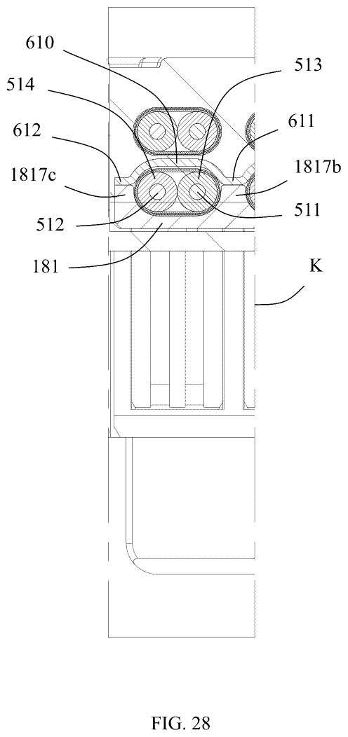

Referring to FIG. 7 to FIG. 29, the electrical connector 100 includes an insulating body 1, a plurality of conductive terminals 2 directly or indirectly fixed to the insulating body 1, a movable component 3 installed on the insulating body 1, an elastic component 4 abutting against the movable component 3, a cable 5 electrically connected to the conductive terminal 2, a cover plate 6 that is fastened on the insulating body 1 and at least partially abuts against the cable 5, and a pull strap 7 connected to the movable component 3. The pull strap 7 is configured to drive the movable component 3 to overcome the force of the elastic component 4, so that the movable component 3 is able to move along a moving direction C (as shown in FIG. 3) perpendicular to the mating direction B.

In the illustrated embodiment of the present disclosure, the insulating body 1 includes a main body 11, an extension plate 12 protruding downwardly from the main body 11 along the mating direction B, and a positioning plate 13 further protruding downwardly from the extension plate 12 along the mating direction B. In the illustrated embodiment of the present disclosure, a dimension of the main body 11 in a front-rear direction/a second direction, a dimension of the extension plate 12 in the front-rear direction, and a dimension of the positioning plate 13 in the front-rear direction become smaller in sequence, so that the insulating body 1 is roughly of a stepped configuration. The positioning plate 13 includes a first positioning piece 131 located in a middle, a second positioning piece 132 located on one side of the first positioning piece 131, and a third positioning piece 133 located on another side of the first positioning piece 131. The second positioning piece 132 is spaced apart from the first positioning piece 131. The third positioning piece 133 is spaced apart from the first positioning piece 131. A dimension of the first positioning piece 131 along a left-right direction/a first direction is larger than a dimension of the second positioning piece 132 along the left-right direction. The dimension of the first positioning piece 131 along the left-right direction is also larger than a dimension of the third positioning piece 133 along the left-right direction. It is known that, the left-right direction is perpendicular to both the top-bottom direction and the front-rear direction. In the illustrated embodiment of the present disclosure, a distance between the first positioning piece 131 and the second positioning piece 132 is different from a distance between the first positioning piece 131 and the third positioning piece 133. This arrangement prevents the electrical connector 100 from being inserted into the mating connector 200 at a wrong angle, so that a certain foolproof effect can be achieved.

The main body 11 includes a first end wall 111 (for example, a front end wall) and a second end wall 112 (for example, a rear end wall) opposite to the first end wall 111. The main body 11 further includes a receiving space 110 extending forwardly through the first end wall 111, a first receiving groove 113 located on one side (for example, a left side) of the receiving space 110, and a second receiving groove 114 located on another side (for example, a right side) of the receiving space 110. The receiving space 110 does not extend backwardly through the second end wall 112. The main body 11 includes an inner wall surface 115 exposed to the receiving space 110. The first receiving groove 113 and the second receiving groove 114 extend through the second end wall 112 along the moving direction C.

The main body 11 includes a top surface 116, an opening 1160 extending upwardly through the top surface 116, a first mounting hole 1161 extending upwardly through the top surface 116 and located on one side of the opening 1160, a second mounting hole 1162 extending upwardly through the top surface 116 and located on another side of the opening 1160, a first installation groove 1163 extending through the main body 11 and communicating with the opening 1160, and a second installation groove 1164 extending through main body 11 and communicating with the opening 1160. In the illustrated embodiment of the present disclosure, the first installation groove 1163 and the second installation groove 1164 are located on two sides (for example, front and rear sides) of the extension plate 12, respectively. The main body 11 further includes a fixing plate 117 located between the first end wall 111 and the second end wall 112. In the illustrated embodiment of the present disclosure, the fixing plate 117 is a vertical plate. The fixing plate 117 includes a pull strap groove 1170 extending therethrough along the moving direction C, and a pull strap shaft 1171 located between an edge (for example, an upper edge) of the fixing plate 117 and the pull strap groove 1170. The pull strap 7 extends through the pull strap groove 1170 along the moving direction C from a connection with the movable component 3, and the pull strap is bent along the pull strap shaft 1171 and then extends out of the main body 11. The fixing plate 117 further includes at least one receiving hole 1172. In the illustrated embodiment of the present disclosure, the number of the receiving holes 1172 is two. The receiving holes 1172 are exposed on a surface of the fixing plate 117 and face towards the movable component 3. One end of the elastic component 4 is disposed in the receiving hole 1172 and another end of the elastic component 4 abuts against the movable component 3.

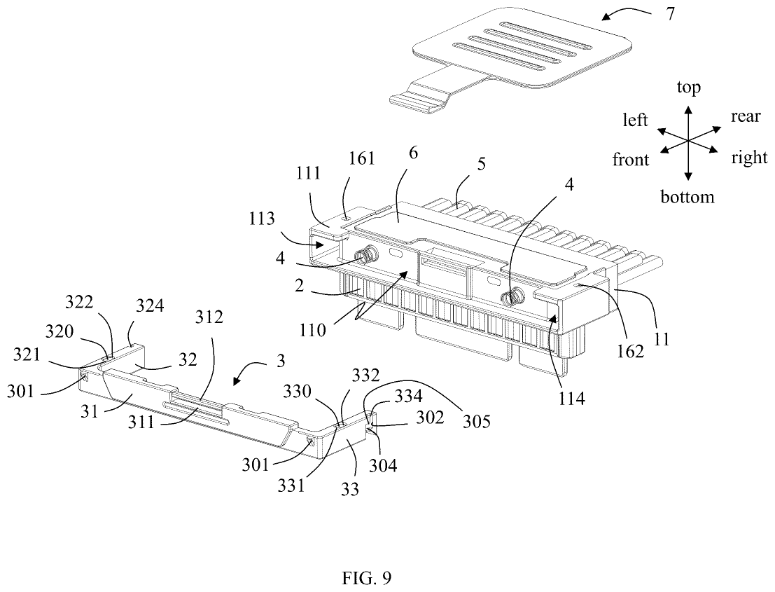

Referring to FIG. 9 to FIG. 29, in the illustrated embodiment of the present disclosure, the electrical connector 100 includes a first terminal module M1 and a second terminal module M2. The first terminal module M1 includes a first conductive mounting block 181, a plurality of first terminal assemblies 10 mounted to the first conductive mounting block 181, a plurality of first cables 51 connected to the first terminal assemblies 10, and a first ground plate 61 abutting against the first conductive mounting block 181. Each first terminal assembly 10 includes a first insulating block 171 and a plurality of first conductive terminals 23 provided on the first insulating block 171. In the illustrated embodiment of the present disclosure, the first conductive terminals 23 are insert-molded with the first insulating block 171. Of course, it is understandable to those skilled in the art that in other embodiments, the first conductive terminals 23 can also be fixed to the first insulating block 171 by assembling.

In the illustrated embodiment of the present disclosure, the first conductive mounting block 181 is made of metal material to provide better shielding effect. The first conductive terminals 23 are not in contact with the first conductive mounting block 181 through the first insulating block 171, thereby preventing short circuit. The first conductive mounting block 181 includes a first base portion 1810, a first protruding portion 1811 extending downwardly from the first base portion 1810, and a first extension portion 1817 extending backwardly from the first base portion 1810. The first base portion 1810 includes a plurality of first recessed grooves 1810a spaced apart along the left-right direction, a plurality of first side wall portions 1810b each located on one side of each first recessed groove 1810a, a plurality of second side wall portions 1810c each located on another side of each first recessed groove 1810a, and an end wall portion 1810f connecting the first side wall portion 1810b and the second side wall portion 1810c. The first recessed groove 1810a is a U-shaped groove, which is at least surrounded by the first side wall portion 1810b, the second side wall portion 1810c and the end wall portion 1810f. The first side wall portion 1810b is provided with a first outer surface 1810d. The second side wall portion 1810c is provided with a second outer surface 1810e. The end wall portion 1810f is provided with a third outer surface 1810g.

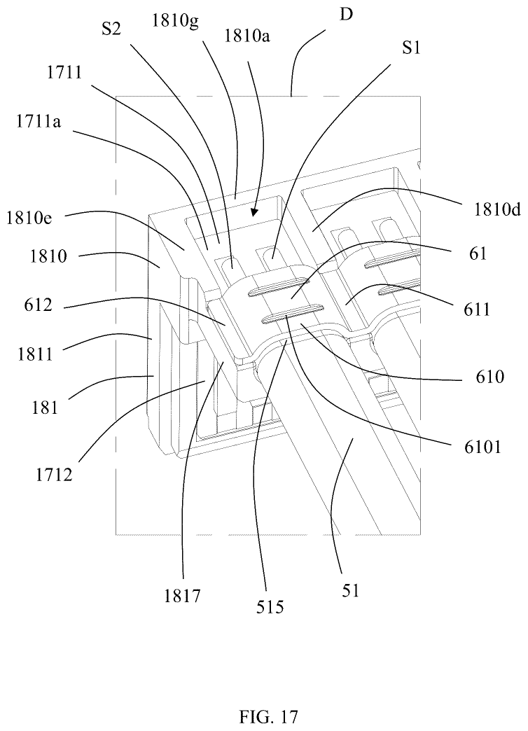

The first extension portion 1817 includes a first accommodating groove 1817a, a first abutting surface 1817b located on one side of the first accommodating groove 1817a and a second abutting surface 1817c located on another side of the first accommodating groove 1817a. The first accommodating groove 1817a is in communication with the first recessed groove 1810a. The first cable 51 is at least partially received in the first accommodating groove 1817a. Referring to FIG. 17 to FIG. 19, in the first embodiment of the present disclosure, the first outer surface 1810d of the first side wall portion 1810b, the second outer surface 1810e of the second side wall portion 1810c and the third outer surface 1810g of the end wall portion 1810f are located in a same plane. The first abutting surface 1817b and the second abutting surface 1817c are located in another lower plane. The first extension portion 1817 further includes a plurality of first abutting ribs 1817d protruding into the first accommodating groove 1817a.

The first protruding portion 1811 defines a plurality of first assembly grooves 1811a corresponding to the first recessed grooves 1810a, a plurality of first convex ribs 1811b and a plurality of second convex ribs 1811c. Two sides of each first assembly groove 1811a are associated with one first convex rib 1811b and one second convex rib 1811c, respectively. The first assembly groove 1811a extends downwardly through an end surface 1812 of the first protruding portion 1811. The first assembly groove 1811a is in communication with the first recessed groove 1810a. The first convex rib 1811b is provided with a first surface 1811d. The second convex rib 1811c is provided with a second surface 1811e. The first convex rib 1811b and the second convex rib 1811c serve as ground terminals to mate with the mating connector 200. In addition, in order to improve the ground shielding effect, the first surface 1811d of the first convex rib 1811b and the second surface 1811e of the second convex rib 1811c may be coated with a plating layer. The plating layer is a gold plating layer or a plating layer of other metals, so as to form good conduction with the mating end.

The first insulating block 171 is provided with a first end portion 1711 received in the first recessed groove 1810a and a first insertion portion 1712 extending from the first end portion 1711. The first insertion portion 1712 is inserted into the first assembly groove 1811a. In the illustrated embodiment of the present disclosure, the first end portion 1711 is provided with an upper surface 1711a. When the first end portion 1711 is received in the first recessed groove 1810a and installed in place, the first end portion 1711 is completely located in the first recessed groove 1810a. At this time, the first outer surface 1810d of the first side wall portion 1810b, the second outer surface 1810e of the second side wall portion 1810c and the third outer surface 1810g of the end wall portion 1810f are all higher than the upper surface 1711a.

Preferably, in order to increase the transmission rate, in the illustrated embodiment of the present disclosure, two first conductive terminals 23 are provided and located on the same first insulating block 171, and they are a first signal terminal S1 and a second signal terminal S2, respectively. The first signal terminal S1 and the second signal terminal S2 form a differential pair. The first convex rib 1811b and the second convex rib 1811c are located on two sides of the differential pair, respectively, and the end wall portion 1810f is located at a front end of the differential pair, in order to improve the quality of signal transmission. In the illustrated embodiment of the present disclosure, by providing the U-shaped first recessed groove 1810a, the first conductive mounting block 181 is capable of covering the differential pair on three sides, thereby improving the quality of signal transmission. In the illustrated embodiment of the present disclosure, each conductive terminal 2 is generally L-shaped and includes a mating portion 21 and a connecting portion 22 electrically connected to the cable 5. The connecting portion 22 is perpendicular to the mating portion 21. The mating portion 21 includes a mating surface 211. The mating surface 211 is exposed to a surface of the first insertion portion 1712. The connecting portion 22 includes a welding surface 221. The welding surface 221 is exposed to the first end portion 1711. In the illustrated embodiment of the present disclosure, the mating portion 21 is flat-shaped. The connecting portion 22 of the first signal terminal S1 and the connecting portion 22 of the second signal terminal S2 are both located in the first recessed groove 1810a.

The first cable 51 includes a first core 511, a second core 512, an first insulation layer 513 wrapped on the first core 511, a second insulation layer 514 wrapped on the second core 512, a first shielding layer 515 located outside the first insulation layer 513 and the second insulation layer 514, and an outermost insulation skin 517. In the illustrated embodiment of the present disclosure, the first cable 51 is not provided with any ground cable in order to simplify its structure.

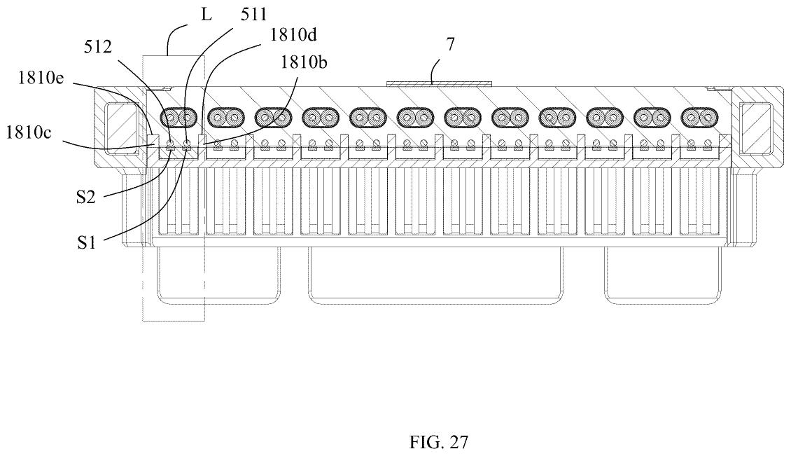

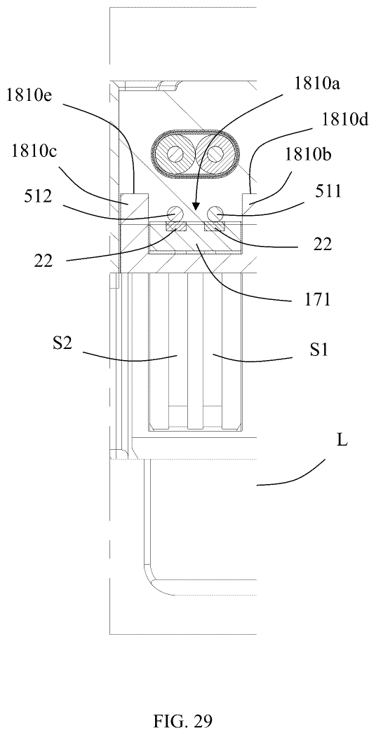

In the illustrated embodiment of the present disclosure, the first core 511 and the second core 512 are fixed to the welding surface 221 of the first signal terminal S1 and the welding surface 221 of the second signal terminal S2, respectively, by soldering or welding. In the illustrated embodiment of the present disclosure, as shown in FIG. 27 and FIG. 29, the first core 511 and the second core 512 are both located in the first recessed groove 1810a. The first outer surface 1810d of the first side wall portion 1810b, the second outer surface 1810e of the second side wall portion 1810c, and the third outer surface 1810g of the end wall portion 1810f all protrude beyond the first core 511 and the second core 512. With this arrangement, it is beneficial to better shield the combination position of the first core 511 and the first signal terminal S1, and the combination position of the second core 512 and the second signal terminal S2 to improve the quality of signal transmission.

The first ground plate 61 is made of metal material and includes a first raised portion 610, a first abutting portion 611 connected to one side of the first raised portion 610, and a second abutting portion 612 connected to another side of the first raised portion 610. The first raised portion 610 includes a plurality of second abutting ribs 6101 located on a bottom surface thereof. The first shielding layer 515 of the first cable 51 is sandwiched between the first conductive mounting block 181 and the first ground plate 61. The first abutting rib 1817d and the second abutting rib 6101 are both in contact with the first shielding layer 515. With this arrangement, the first ground plate 61, the first shielding layer 515 of the first cable 51 and the first conductive mounting block 181 are connected in series to form a whole with a relatively large grounding area, which improves the quality of signal transmission.

Specifically, the first shielding layer 515 of the first cable 51 is sandwiched between the first conductive mounting block 181 and the first raised portion 610. The first abutting portion 611 is in contact with the first abutting surface 1817b. The second abutting portion 612 is in contact with the second abutting surface 1817c. In an embodiment of the present disclosure, the first abutting portion 611 and the first abutting surface 1817b are fixed by soldering or welding. The second abutting portion 612 and the second abutting surface 1817c are fixed by soldering or welding.

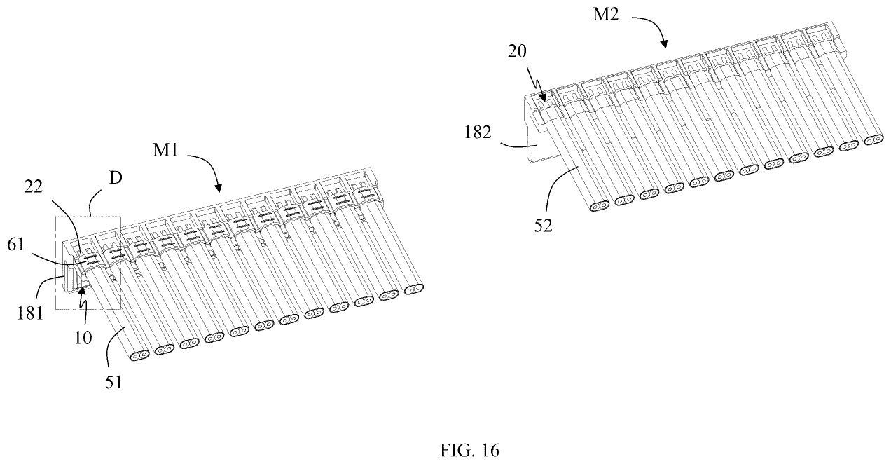

Referring to FIG. 16, in the first embodiment of the present disclosure, the first outer surface 1810d of the first side wall portion 1810b, the second outer surface 1810e of the second side wall portion 1810c, the third outer surface 1810g of the end wall portion 1810f and the first recessed groove 1810a are all exposed to the first ground plate 61.

The second terminal module M2 includes a second conductive mounting block 182, a plurality of second terminal assemblies 20 fixed to the second conductive mounting block 182, and a plurality of second cables 52 connected to the second terminal assemblies 20. Each second terminal assembly 20 includes a second insulating block 172 and a plurality of second conductive terminals 24 provided on the second insulating block 172. The second terminal module M2 has the similar structure as the first terminal module M1. Of course, it is understandable to those skilled in the art that the second terminal module M2 may also be provided with a first ground plate 61 similar to that of the first terminal module M1, which will not be described again in the present disclosure.

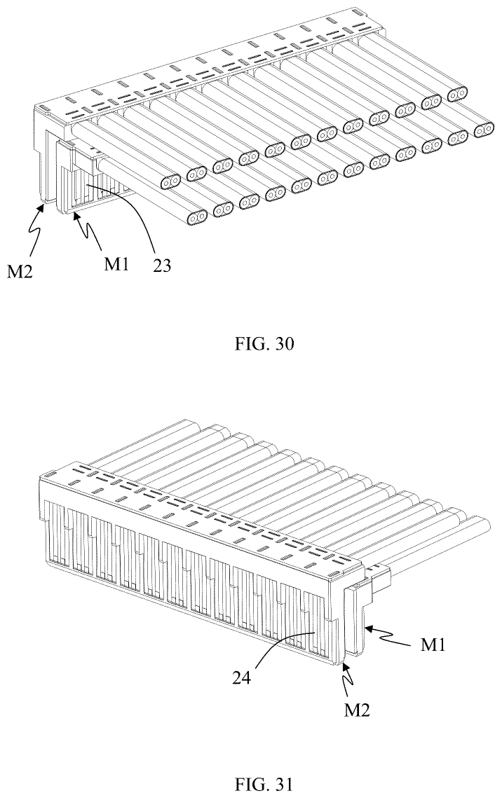

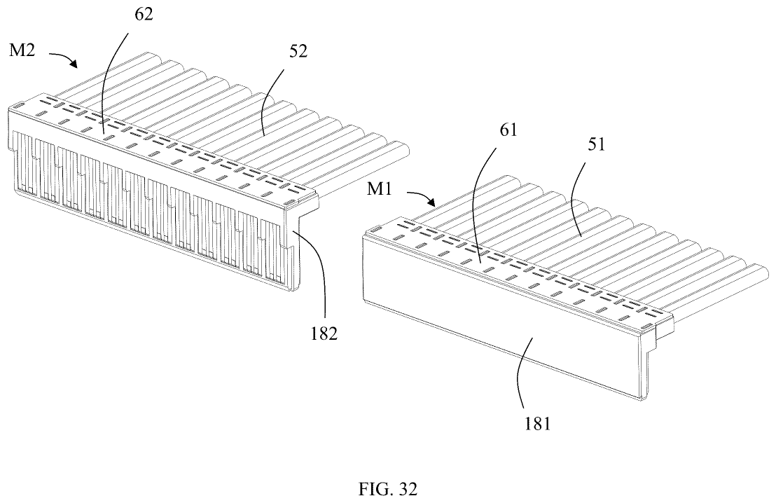

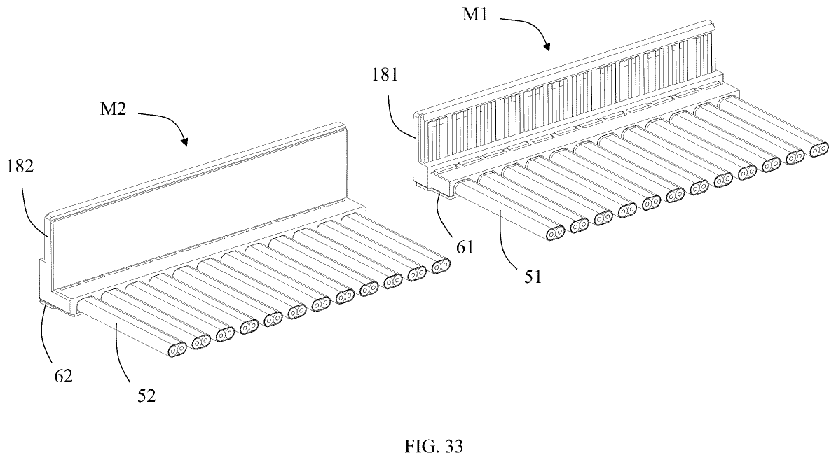

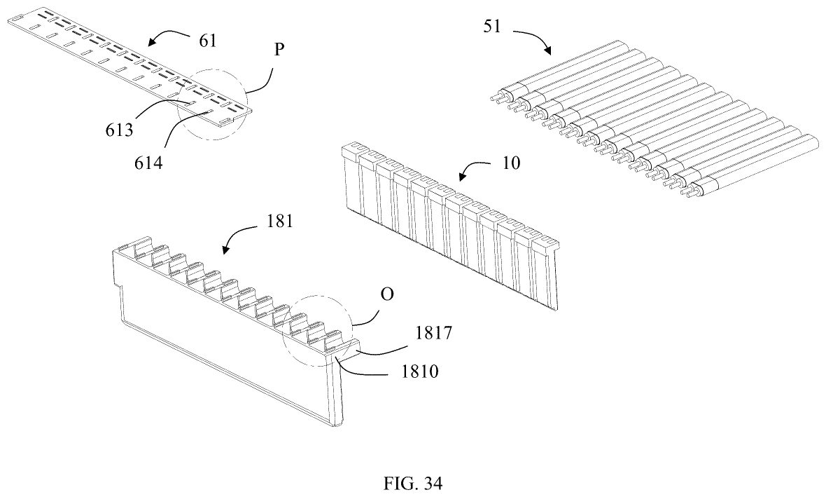

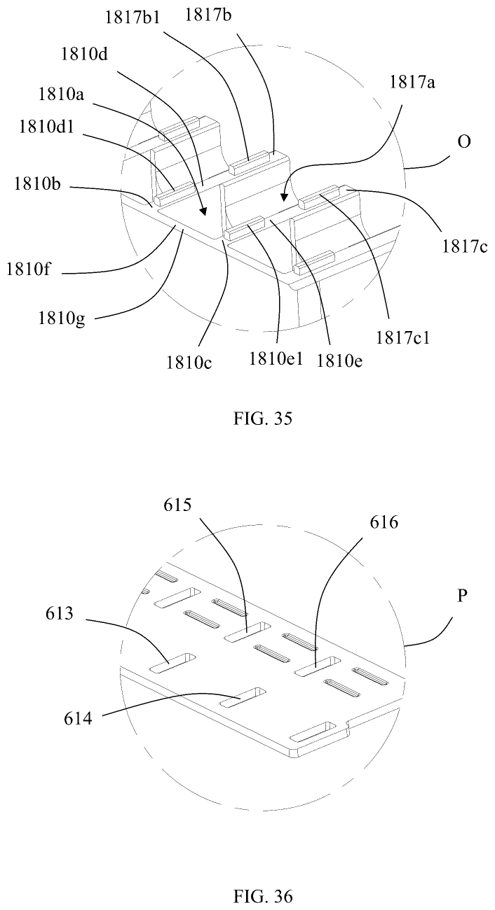

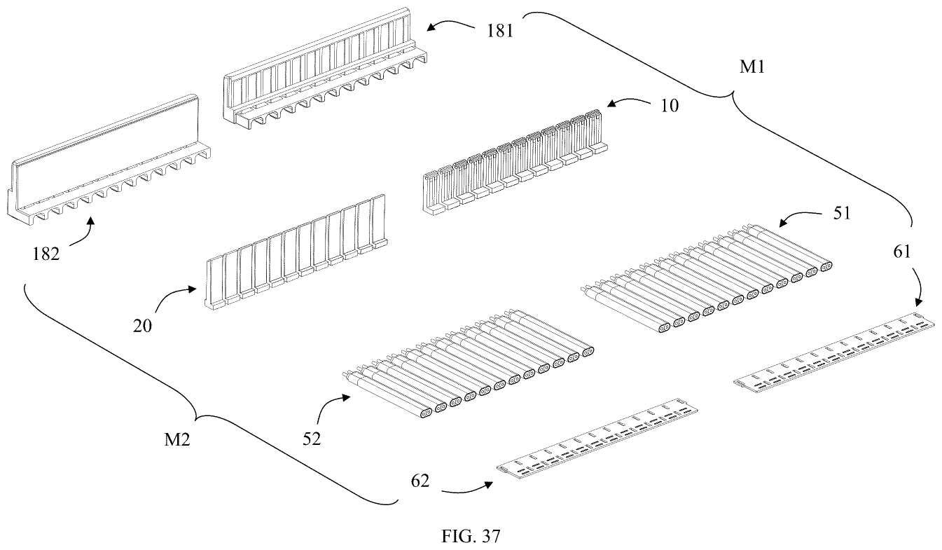

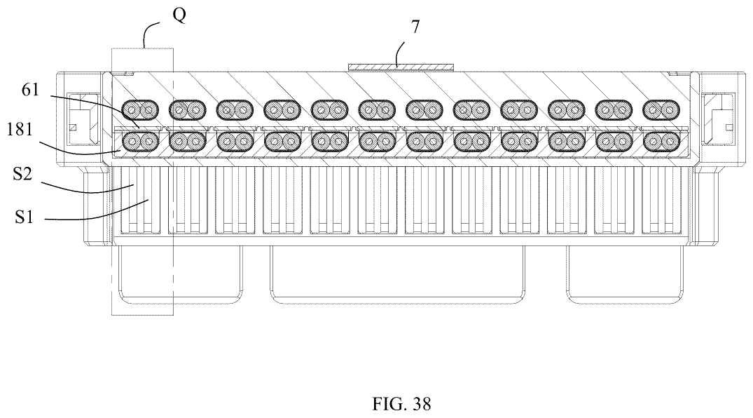

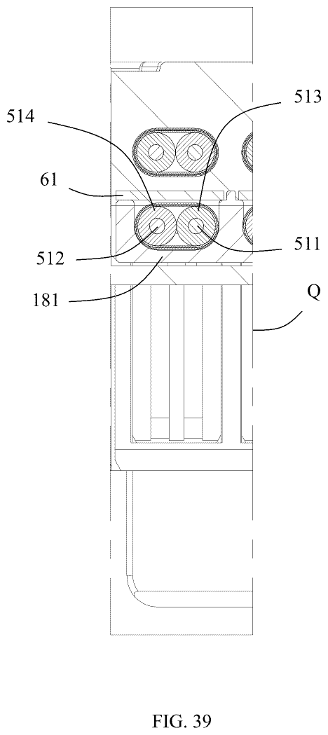

Referring to FIG. 30 to FIG. 39, in the second embodiment of the electrical connector 100 of the present disclosure, in order to further improve the shielding effect, the first ground plate 61 covers the first outer surface 1810d of the first side wall portion 1810b, the second outer surface 1810e of the second side wall portion 1810c, the third outer surface 1810g of the end wall portion 1810f, the first recessed groove 1810a, the first abutting surface 1817b and the second abutting surface 1817c. The first ground plate 61 is roughly flat-shaped. The first outer surface 1810d of the first side wall portion 1810b, the second outer surface 1810e of the second side wall portion 1810c, the third outer surface 1810g of the end wall portion 1810f, the first abutting surface 1817b and the second abutting surface 1817c are all located in the same plane.

At least one of the first base portion 1810 and the first extension portion 1817 is provided with a rib. The first ground plate 61 defines a slot that receives the rib. Specifically, in the second embodiment illustrated in the present disclosure, the first side wall portion 1810b is provided with a first rib 1810d1 protruding beyond the first outer surface 1810d; the second side wall portion 1810c is provided with a second rib 1810e1 protruding beyond the second outer surface 1810e; the first extension portion 1817 is provided with a third rib 1817b1 protruding beyond the first abutting surface 1817b; the first extension portion 1817 is provided with a fourth rib 1817cl protruding beyond the second abutting surface 1817c. Correspondingly, the first ground plate 61 defines a first slot 613 mating with the first rib 1810d1, a second slot 614 mating with the second rib 1810e1, a third slot 615 mating with the third rib 1817b1, and a fourth slot 616 mating with the fourth rib 1817c1. The rib includes at least one of the first rib 1810d1, the second rib 1810e1, the third rib 1817b1, and the fourth rib 1817c1. The slot includes at least one of the first slot 613, the second slot 614, the third slot 615 and the fourth slot 616.

In the second embodiment of the present disclosure, the second terminal module M2 includes a second conductive mounting block 182, a plurality of second terminal assemblies 20 mounted to the second conductive mounting block 182, a plurality of second cables 52 connected to the second terminal assemblies 20, and a second ground plate 62 abutting against the second conductive mounting block 182. Each second terminal assembly 20 includes a second insulating block 172 and a plurality of second conductive terminals 24 provided on the second insulating block 172. The second terminal module M2 has the same structure as the first terminal module M1 and will not be described again in the present disclosure.

In the illustrated embodiment of the present disclosure, the cable 5 extends beyond the main body 11 along the moving direction C.

Referring to FIG. 7 to FIG. 12, the movable component 3 is at least partially installed to the main body 11. The movable component 3 includes a base 31, a first ejector rod 32 extending backwardly from one side of the base 31, and a second ejector rod 33 extending backwardly from another side of the base 31. The base 31 is accommodated in the receiving space 110. Most of the first ejector rod 32 is accommodated in the first receiving groove 113 except a rear end of the first ejector rod 32 which extends out of the first receiving groove 113. Most of the second ejector rod 33 is accommodated in the second receiving groove 114 except a rear end of the second ejector rod 33 which extends out of the second receiving groove 114. Both the first ejector rod 32 and the second ejector rod 33 can be referred to as ejector rods which extend from the first end wall 111 to the second end wall 112 with the rear ends thereof protruding beyond the second end wall 112.

The base 31 includes two first locking protrusions 301 located on two sides (for example, left and right sides) of the base 31, respectively, so as to improve the mating retention force. The first locking protrusions 301 are integrally formed with the main body 11 and extend forwardly beyond the first end wall 111. Of course, in another embodiment, the first locking protrusions 301 and the main body 11 can also be manufactured separately, and then assembled and fixed together. In this case, the first locking protrusions 301 can be made of a material, for example, a wear-resistant material with better structural strength, different from that of the main body 11. The base 31 further includes a pull strap connecting portion 312 to which the pull strap 7 is connected. The movable component 3 includes a transverse slot 311 extending through the base 31 along the moving direction C. The pull strap connecting portion 312 is located above the transverse slot 311. The pull strap connecting portion 312 is similar to a shaft portion, and is located between the transverse slot 311 and the edge (for example, the upper edge) of the base 31. One end of the pull strap 7 passes through the transverse slot 311 and is sleeved around the pull strap connecting portion 312.

In an alternative embodiment of the present disclosure, the number of the first locking protrusion 301 can be only one and the first locking protrusion 301 protrudes forwardly from a middle part of the first end wall 111. The first locking protrusion 301 has same distances to both the left-front side of the base 31 and the right-front side of the base 31.

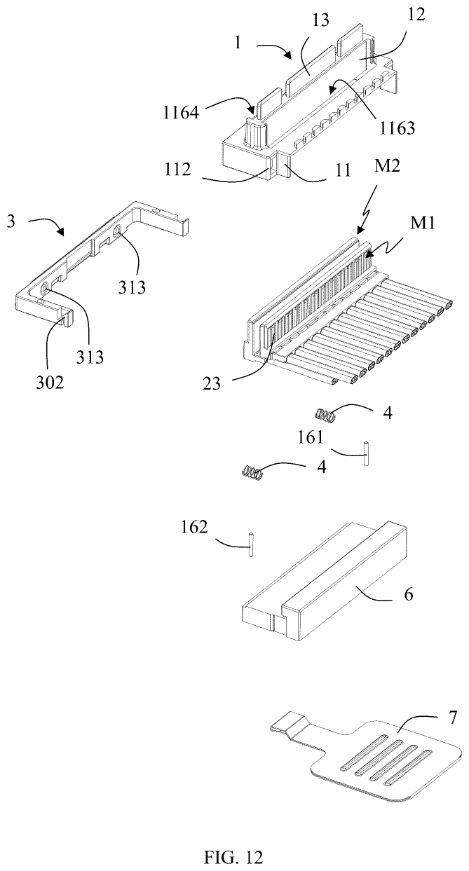

In the illustrated embodiment of the present disclosure, the elastic component 4 is a compression spring installed between the base 31 and the inner wall surface 115 of the main body 11. The number of the compression springs is two, and the two compression springs are arranged side by side to improve the stability of the moving element 3 when the moving element 3 is moving. Besides, referring to FIG. 12, in order to better positioning the compression spring, the base 31 is further provided with a positioning post 313 which is at least partially inserted into the compression spring.

The movable component 3 further includes at least one second locking protrusion 302 protruding backwardly beyond the second end wall 112. In the illustrated embodiment of the present disclosure, the number of the second locking protrusions 302 is two. One of the second locking protrusions 302 is located at the rear end of the first ejector rod 32 away from the base 31. The one of the second locking protrusions 302 is located outside the first receiving groove 113 and protrudes toward the first receiving groove 113. A remaining one of the second locking protrusions 302 is located at the rear end of the second ejector rod 33 away from the base 31. The remaining one of the second locking protrusions 302 is located outside the second receiving groove 114 and protrudes toward the second receiving groove 114. The two second locking protrusions 302 are arranged in such a manner to improve an engagement force. The second locking protrusion 302 is integrally formed with a corresponding ejector rod to save cost. Of course, in another embodiment, the second locking protrusion 302 and the corresponding ejector rod can also be produced separately, and then assembled and fixed together. In this case, the second locking protrusion 302 can be made of a different material from that of the corresponding ejector rod. The first locking protrusions 301 and the second locking protrusions 302 are to lock with locking holes of the mating connector 200 to improve the mating retention force.

The two first locking protrusions 301 and the two second locking protrusions 302 are both arranged on the left side and the right side of the electrical connector, so that the present disclosure can realize a double-side locking purpose, thereby improving the mating retention force between the electrical connector and the mating connector. In an alternative embodiment, the only one first locking protrusion 301 is arranged on the middle part of the electrical connector and the two second locking protrusions 302 are arranged on the left side and the right side of the electrical connector, which can also realize the double-side locking purpose, thereby improving the mating retention force between the electrical connector and the mating connector.

The first ejector rod 32 includes a first limiting groove 320 located in the middle, a first limiting surface 321 located at one end of the first limiting groove 320 along the moving direction C, and a second limiting surface 322 is located at another end of the first limiting groove 320 along the moving direction C. Compared with the second limiting surface 322, the first limiting surface 321 is closer to the first end wall 111.

Similarly, the second ejector rod 33 includes a second limiting groove 330 located in the middle, a third limiting surface 331 located at one end of the second limiting groove 330 along the moving direction C, and a fourth limiting surface 332 is located at another end of the second limiting groove 330 along the moving direction C. Compared with the fourth limiting surface 332, the third limiting surface 331 is closer to the first end wall 111.

The first ejector rod 32 further includes a first concave groove 324 located at a distal end (for example, a rear end) thereof, and the second ejector rod 33 further includes a second concave groove 334 located at a distal end (for example, a rear end) thereof. Both the first concave groove 324 and the second concave groove 334 are referred to as groove portions. Each groove portion has a first blocking wall 303 (for example, a rear blocking wall), a second blocking wall 304 (for example, a front lower blocking wall) and a third blocking wall 305 (for example, a front upper blocking wall). The second blocking wall 304 is located below the first blocking wall 303 to face the first blocking wall 303. The third blocking wall 305 is located above the first blocking wall 303 to face the first blocking wall 303. A large-diameter portion (not numbered) is formed between the first blocking wall 303 and the second blocking wall 304, and a small-diameter portion (not numbered) is formed between the first blocking wall 303 and the third blocking wall 305. A dimension of the small-diameter portion in the front-rear direction is smaller than a dimension of the large-diameter portion in the front-rear direction.

It should be noted that: in this embodiment, the groove portion extends vertically, and includes the small-diameter portion and the large-diameter portion. The small-diameter portion exists according to the manufacturing process of the groove portion. In another embodiment, the groove portion does not include the small-diameter portion and only includes the large-diameter portion, so that when the insertion plate portion 8321 is accommodated in the groove portion which only includes the large-diameter portion, the groove portion can move together with the movable component 3 in the front-rear direction, and the second locking protrusion 302 can be inserted into the second locking hole 8322 of the insertion plate portion 8321 for engagement.

The second locking protrusion 302 protrudes from the bottom of the first blocking wall 303 toward the second blocking wall 304. The second locking protrusion 302 is spaced from the second blocking wall 304 by a distance. Because the first locking protrusion 301 also protrudes from the rear to the front, the first locking protrusion 301 and the second locking protrusion 302 in the present disclosure have the same forward protruding direction. The forward protruding direction is opposite to the moving direction C.

The electrical connector 100 includes a first pin 151 fixed in the first mounting hole 1161 and a second pin 152 fixed in the second mounting hole 1162. The first pin 151 is inserted into the first limiting groove 320 and the second pin 152 is inserted into the second limiting groove 330. A dimension of the first limiting groove 320 is larger than a dimension of the first pin 151 along the moving direction C. A dimension of the second limiting groove 330 is larger than a dimension of the second pin 152 along the moving direction C. The first limiting surface 321 is used for engaging with the first pin 151, and the third limiting surface 331 is used for engaging with the second pin 152, so as to prevent the movable component 3 from moving excessively along the moving direction C. The second limiting surface 322 is used for engaging with the first pin 151, and the fourth limiting surface 332 is used for engaging with the second pin 152, so as to prevent the movable component 3 from returning excessively along an opposite direction of the moving direction C.

The cover plate 6 is accommodated and fixed in the opening 1160 of the main body 11, and the pull strap 7 extends out of the cover plate 6. The cover plate 6 presses against the connection between the cables 5 and the conductive terminals 2 (for example, welding portions of the cables 5 and the conductive terminals 2), so as to play a protection role.

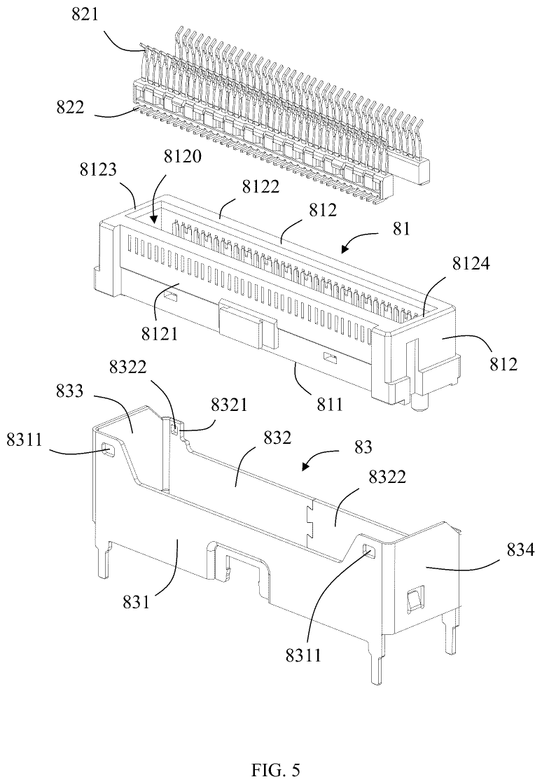

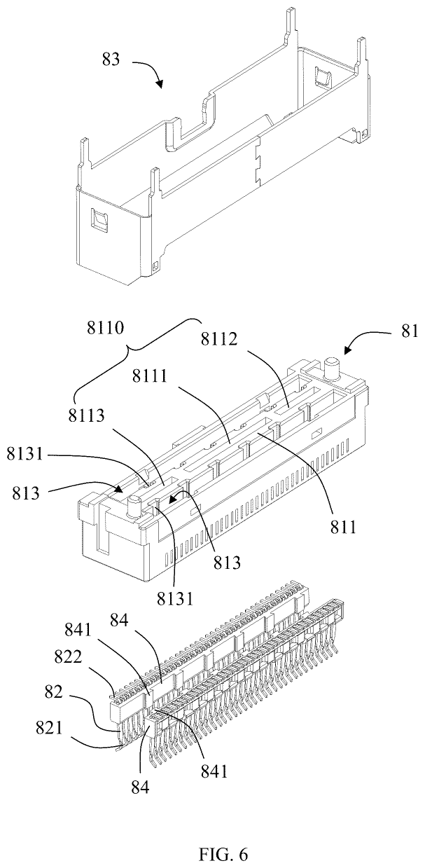

Referring to FIG. 3 to FIG. 6, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811. Referring to FIG. 5, the plurality of wall portions 812 include a first wall portion 8121, a second wall portion 8122 disposed opposite to the first wall portion 8121, a first connecting wall portion 8123 connecting one side of the first wall portion 8121 and one side of the second wall portion 8122, and a second connecting wall portion 8124 connecting another side of the first wall portion 8121 and another side of the second wall portion 8122. The bottom wall 811 defines a positioning groove 8110 for accommodating the positioning plate 13. Specifically, the positioning groove 8110 includes a first positioning groove 8111 for accommodating the first positioning piece 131, a second positioning groove 8112 for accommodating the second positioning piece 132, and a third positioning groove 8113 for accommodating the third positioning piece 133. The first positioning groove 8111, the second positioning groove 8112 and the third positioning groove 8113 all extend through the bottom wall 811.

The mating connector 200 includes a terminal fixing block 84 to which the mating terminals 82 are fixed. The mating insulating body 81 includes a terminal accommodating groove 813 in which the terminal fixing block 84 is fixed. The terminal fixing block 84 includes a first engaging portion 841. A second engaging portion 8131 is provided on one side of the terminal accommodating groove 813. The first engaging portion 841 and the second engaging portion 8131 are engaged with each other, so that the terminal fixing block 84 is fixed in the terminal accommodating groove 813. In the illustrated embodiment of the present disclosure, the first engaging portion 841 is a dovetail-shaped bump and the second engaging portion 8131 is a dovetail-shaped groove matching the dovetail-shaped bump.

In some embodiments, the number of the terminal fixing blocks 84 is two, and the two terminal fixing blocks 84 are symmetrical and spaced apart from each other. The mating terminals 82 are arranged in two symmetrical rows and the two rows of mating terminals 82 are fixed to the two terminal fixing blocks 84, respectively. Two terminal accommodating grooves 813 are provided, and the two terminal accommodating grooves 813 are symmetrical and spaced apart from each other. The two terminal accommodating grooves 813 are respectively formed between the bottom wall 811 and the two opposite wall portions 812. The two terminal fixing blocks 84 are fixed in the two terminal accommodating grooves 813. Each of the terminal fixing blocks 84 includes a plurality of first engaging portions 841. One side of each of the terminal accommodating grooves 813 includes a plurality of second engaging portions 8131 corresponding to the plurality of first engaging portions 841 respectively. Each of the first engaging portions 841 and the corresponding second engaging portions 8131 are engaged with each other, so that each terminal fixing block 84 is fixed in the corresponding terminal accommodating groove 813. The first engaging portions 841 are respectively disposed on the sides of the two terminal fixing blocks 84 facing each other. The second engaging portions 8131 are respectively disposed on opposite sides of the bottom wall 811 facing the two terminal accommodating grooves 813.

The wall portions 812 are enclosed to form a mating slot 8120 for receiving the tongue plate 1a. The mating terminals 82 are arranged in two rows. Each mating terminal 82 includes an elastic mating arm 821 and a mounting tail 822. The mounting tail 822 is used for being mounted on a circuit board. The elastic mating arm 821 extends into the mating slot 8120 for being in contact with the mating portion 21.

The metal shell 83 includes a first side wall 831, a second side wall 832, a first connecting wall 833, and a second connecting wall 834. The second side wall 832 is disposed opposite to the first side wall 831. The first connecting wall 833 connects one side of the first side wall 831 and one side of the second side wall 832. The second connecting wall 834 connects another side of the first side wall 831 and another side of the second side wall 832. The first side wall 831 defines a first locking hole 8311 engaged with the first locking protrusion 301. The second side wall 832 includes two insertion plate portion 8321 at a corner adjacent to the first connecting wall 833 and at a corner adjacent to the second connecting wall 834. That is to say, each of the left and right sides of the second side wall 832 includes one insertion plate portion 8321. The insertion plate portion 8321 defines a second locking hole 8322 matched with the second locking protrusion 302. The insertion plate portion 8321 is integrally formed on the second side wall 832. The insertion plate portion 8321 and the first connecting wall 833 are integrally formed, and the insertion plate portion 8321 and the second connecting wall 834 are also integrally formed without any gap. Therefore, the insertion plate portion 8321 has no elasticity.

When the electrical connector 100 is inserted into the mating connector 200, the positioning plate 13 is correspondingly accommodated in the positioning groove 8110, the tongue plate 1a is correspondingly accommodated in the mating slot 8120, and the mating portions 21 of the conductive terminals 2 correspondingly contact the elastic mating arms 821 of the mating terminals 82. With the insertion of the electrical connector 100, the inclined surface of the first locking protrusion 301 abuts against the first side wall 831, and the inclined surface of the second locking protrusion 302 abuts against the second side wall 832. The movable component 3 overcomes the force of the elastic component 4, and shrinks inward by a certain distance along the moving direction C. When the first locking protrusion 301 moves downwardly to the first locking hole 8311, and the second locking protrusion 302 moves downwardly to the second locking hole 8322, the elastic force of the elastic component 4 is released, so that the movable component 3 moves backwardly in the direction opposite to the moving direction C. The first locking protrusion 301 protrudes forwardly into the first locking hole 8311, and the second locking protrusion 302 protrudes forwardly and protrudes into the second locking hole 8322, thereby realizing the locking of the electrical connector 100 and the mating connector 200.

In the present disclosure, by providing the first locking protrusion 301 and the second locking protrusion 302 on two sides, two-side locking in the front-rear direction/the second direction can be achieved, thereby improving the mating reliability, and reducing the risk of the electrical connector 100 and the mating connector 200 becoming loose or tilted.

When the electrical connector 100 and the mating connector 200 need to be unlocked, an external force is applied to pull the pull strap 7, and the pull strap 7 generates a component force along the moving direction C, and the component force in this direction overcomes the force of the elastic component 4, so that the movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other. In other words, the electrical connector 100 and the mating connector 200 are unlocked on two sides. As a result, the electrical connector 100 can be pulled out of the mating connector 200 by applying another force or by an upward component force exerted on the pull strap 7.

The insertion plate portion 8321 is accommodated in the large-diameter portion of the groove portion in both the locked state of the electrical connector 100 and the mating connector 200, and the unlocked state of the electrical connector 100 and the mating connector 200. When the movable component 3 drives the second locking protrusion 302 to move, and the second locking protrusion 302 cooperates with the second locking hole 8322, the insertion plate portion 8321 is in contact with the first blocking wall 303, and the insertion plate portion 8321 is separated from the second blocking wall 304. When the movable component 3 drives the second locking protrusion 302 to move, and the second locking protrusion 302 and the second locking hole 8322 are disengaged from each other, the insertion plate portion 8321 is in contact with the second blocking wall 304, and the insertion plate portion 8321 is separated from the first blocking wall 303.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body comprising a main body and an extension plate protruding beyond the main body along a mating direction, the main body defining a first installation groove; and
a first terminal module, the first terminal module comprising a first conductive mounting block, a first terminal assembly provided on the first conductive mounting block, a first cable connected to the first terminal assembly, and a first ground plate abutting against the first conductive mounting block; the first terminal assembly comprising a first insulating block and a plurality of first conductive terminals provided on the first insulating block; each first conductive terminal comprising a mating portion and a connecting portion; the connecting portion of the first conductive terminal being electrically connected to the first cable; the first cable comprising a first shielding layer which is sandwiched between the first conductive mounting block and the first ground plate;
wherein the first terminal module at least partially passes through the first installation groove; the first conductive mounting block, the first insulating block and the extension plate together form at least part of a tongue plate of the electrical connector; the tongue plate is configured to be inserted into a mating slot of a mating connector.

2. The electrical connector according to claim 1, wherein the first conductive mounting block is made of metal material; and the first conductive terminals are not in contact with the first conductive mounting block.

3. The electrical connector according to claim 1, wherein the first conductive mounting block comprises a first base portion and a first protruding portion; the first protruding portion defines a first assembly groove;
the first insulating block comprises a first insertion portion received in the first assembly groove; the mating portions of the first conductive terminals are exposed to the first insertion portion.

4. The electrical connector according to claim 3, wherein the first protruding portion comprises a first convex rib and a second convex rib which are located on two sides of the first assembly groove, respectively; the first convex rib and the second convex rib serve as ground terminals to mate with the mating connector.

5. The electrical connector according to claim 3, wherein the first base portion defines a first recessed groove in communication with the first assembly groove; the first insulating block is provided with a first end portion received in the first recessed groove; the connecting portions of the first conductive terminals are provided on the first end portion.

6. The electrical connector according to claim 5, wherein the first base portion comprises a first side wall portion located on one side of the first recessed groove, a second side wall portion located on another side of the first recessed groove, and an end wall portion connecting the first side wall portion and the second side wall portion; the first recessed groove is surrounded by at least the first side wall portion, the second side wall portion and the end wall portion; the first side wall portion comprises a first outer surface; the second side wall portion comprises a second outer surface; the end wall portion comprises a third outer surface;
the plurality of first conductive terminals provided on the first insulating block comprise a first signal terminal and a second signal terminal; the connecting portion of the first signal terminal and the connecting portion of the second signal terminal are both located in the first recessed groove;
the first cable comprises a first core, a second core, a first insulation layer wrapped on the first core, and a second insulation layer wrapped on the second core; the first shielding layer is located outside the first insulating layer and the second insulating layer; the first core is in contact with the connecting portion of the first signal terminal; the second core is in contact with the connecting portion of the second signal terminal.

7. The electrical connector according to claim 6, wherein the first core and the second core are both located in the first recessed groove; the first outer surface of the first side wall portion, the second outer surface of the second side wall portion and the third outer surface of the end wall portion all protrude beyond the first core and the second core.

8. The electrical connector according to claim 6, wherein the first conductive mounting block comprises a first extension portion extending from the first base portion; the first extension portion defines a first accommodating groove, a first abutting surface located on one side of the first accommodating groove and a second abutting surface located on another side of the first accommodating groove;
the first accommodating groove is in communication with the first recessed groove; the first cable is at least partially received in the first accommodating groove;
the first ground plate comprises a first raised portion, a first abutting portion connected to one side of the first raised portion and a second abutting portion connected to another side of the first raised portion; the first shielding layer of the first cable is sandwiched between the first conductive mounting block and the first raised portion; the first abutting portion is in contact with the first abutting surface; the second abutting portion is in contact with the second abutting surface.

9. The electrical connector according to claim 8, wherein the first abutting portion and the first abutting surface are fixed by soldering or welding; the second abutting portion and the second abutting surface are fixed by soldering or welding.

10. The electrical connector according to claim 6, wherein the first outer surface of the first side wall portion, the second outer surface of the second side wall portion, the third outer surface of the end wall portion and the first recessed groove are all exposed to the first ground plate.

11. The electrical connector according to claim 8, wherein the first ground plate covers the first outer surface of the first side wall portion, the second outer surface of the second side wall portion, the third outer surface of the end wall portion, the first recessed groove, the first abutting surface and the second abutting surface.

12. The electrical connector according to claim 11, wherein at least one of the first base portion and the first extension portion is provided with a rib, and the first ground plate defines a slot to receive the rib.

13. The electrical connector according to claim 11, wherein the first ground plate is flat-shaped; the first outer surface of the first side wall portion, the second outer surface of the second side wall portion, the third outer surface of the end wall portion, the first abutting surface and the second abutting surface are all located in a same plane.

14. The electrical connector according to claim 1, wherein the main body defines a second installation groove; the first installation groove and the second installation groove are located on two sides of the extension plate, respectively;
the electrical connector further comprises a second terminal module; the second terminal module comprises a second conductive mounting block, a second terminal assembly mounted to the second conductive mounting block and a plurality of second cables connected to the second terminal assembly; the second terminal assembly comprises a second insulating block and a plurality of second conductive terminals provided on the second insulating block; the second conductive terminals are electrically connected to the second cables;
the second terminal module at least partially passes through the second installation groove; the first conductive mounting block, the first insulating block, the extension plate, the second conductive mounting block and the second insulating block together form the tongue plate.

15. The electrical connector according to claim 1, wherein the main body comprises a first end wall and a second end wall disposed opposite to the first end wall;
the electrical connector further comprises:
a movable component at least partially installed on the main body, the movable component comprising a first locking protrusion protruding beyond the first end wall, an ejector rod extending from the first end wall towards the second end wall, and a second locking protrusion protruding beyond the ejector rod; a rear end of the ejector rod protruding beyond the second end wall; the first locking protrusion and the second locking protrusion being configured to lock with locking holes of a mating connector;
an elastic component abutting against the movable component; and
a pull strap connected to the movable component; the pull strap being configured to drive the movable component to overcome a force of the elastic component, so that the movable component moves along a moving direction perpendicular to the mating direction.

16. The electrical connector according to claim 15, wherein the ejector rod comprises a groove portion; the groove portion comprises a first blocking wall and a second blocking wall which are disposed face to face; the second locking protrusion protrudes from the first blocking wall toward the second blocking wall, and the second locking protrusion is spaced from the second blocking wall by a distance.

17. The electrical connector according to claim 15, wherein the main body comprises a fixing plate located between the first end wall and the second end wall; the fixing plate comprises a pull strap groove extending through the fixing plate along the moving direction, and a pull strap shaft located between an edge of the fixing plate and the pull strap groove; and
wherein the pull strap extends from a connection between the pull strap and the movable component and passes through the pull strap groove along the moving direction, and the pull strap is bent along the pull strap shaft and then extends out of the main body.

18. The electrical connector according to claim 17, wherein the fixing plate defines a receiving hole recessed on a surface of the fixing plate facing towards the movable component, an end of the elastic component is disposed in the receiving hole, and another end of the elastic component abuts against the movable component.

19. The electrical connector according to claim 15, wherein the main body defines a receiving space extending through the first end wall, a first receiving groove located on a side of the receiving space, and a second receiving groove located on another side of the receiving space; the first receiving groove and the second receiving groove extend through the second end wall along the moving direction; and
wherein the movable component comprises a base received in the receiving space; the ejector rod comprises a first ejector rod extending from a side of the base and a second ejector rod extending from another side of the base; the first ejector rod is partially accommodated in the first receiving groove except a rear end of the first ejector rod which extends out of the first receiving groove; the second ejector rod is partially accommodated in the second receiving groove except a rear end of the second ejector rod which extends out of the second receiving groove.

20. An electrical connector assembly, comprising:
an electrical connector, the electrical connector comprising:
an insulating body, the insulating body comprising a main body and an extension plate protruding beyond the main body along a mating direction, the main body defining a first installation groove; and
a first terminal module, the first terminal module comprising a first conductive mounting block, a first terminal assembly, a first cable connected to the first terminal assembly, and a first ground plate abutting against the first conductive mounting block; the first terminal assembly comprising a first insulating block and a plurality of first conductive terminals; each first conductive terminal comprising a mating portion and a connecting portion; the connecting portion of the first conductive terminal being electrically connected to the first cable; the first cable comprising a first shielding layer which is sandwiched between the first conductive mounting block and the first ground plate;
wherein the first terminal module at least partially passes through the first installation groove; the first conductive mounting block, the first insulating block and the extension plate together form at least part of a tongue plate of the electrical connector; the tongue plate is configured to be inserted into a mating slot of a mating connector; and
a mating connector, the mating connector comprising:
a mating insulating body, the mating insulating body comprising a plurality of wall portions and a mating slot surrounded by the plurality of wall portions; the plurality of wall portions comprising a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the tongue plate of the electrical connector;
a plurality of mating terminals, the plurality of mating terminals being provided on the mating insulating body; each mating terminal comprising an elastic mating arm which extends into the mating slot and is configured to contact the first conductive terminal of the electrical connector; and
a metal shell, the metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall.
